(19) United States
(12) Patent Application Publication
(10) Pub. No.: US 2006/0155821 A1
(43) Pub. Date: Jul. 13, 2006

(54) Method and system for sharing information in a network of computers

(76) Inventors: Luigi Pichetti, Roma (IT); Marco Secchi, Roma (IT)

Correspondence Address: IBM CORPORATION;INTELLECTUAL PROPERTY LAW, 11400 BURNET ROAD, AUSTIN, TX, 78758, US

(21) Appl. No.: 10/560,473

(22) PCT Filed: Mar. 23, 2004
(86) PCT No.: PCT/EP04/50348

§ 371 Date: Dec. 12, 2005

(30) Foreign Application Priority Data
Jun. 13, 2003 (EP) 03368053.9

(51) Int. Cl. G06F 15/167

(52) U.S. Cl. 709/213

(57) ABSTRACT

A method and a corresponding system are proposed for sharing information in a network of computers. In the method of the invention, a shortcut (410a,410b) is defined on the desktop (405a,450b) of each computer; the shortcut is associated with an editor, which is invoked passing the name of a shared file (420a,420b) as an argument. Whenever a user needs to transfer information from a first computer to a second computer of the network, the user copies/cuts a block of information into a clipboard of the first computer. The shared file (420a) is opened calling the corresponding shortcut (410a), the block of information is pasted into the shared file from the clipboard, and the file is saved. The user then moves to the second computer, and opens again the shared file (420b) calling the same shortcut (410b). The content of the shared file is copied/cut into a clipboard of the second computer, so as to be available to be pasted to the desired position in a selected window (415b).

### TECHNICAL FIELD

The present invention relates to the data processing field, and more specifically to a method and a corresponding system for sharing information in a network of computers.

### BACKGROUND ART

Sharing of information (such as small blocks of text) is a commonplace activity in a data processing system. For this purpose, many applications implement an internal clipboard; the internal clipboard consists of a temporary storage area (managed by the application itself), which can be used to transfer blocks of information between different positions (for example, in a file being edited). Moreover, modern operating systems typically support a system clipboard, which allows transferring blocks of information between different applications running on the same computer.

A problem arises when the information must be shared between different computers of a network; this problem has been exacerbated in the last years by the widespread diffusion of distributed data processing systems. For example, the need of sharing information in the network is perceived by a user working on two or more computers at the same time, by different users in a cooperative application, and the like. Some solutions have been proposed in order to solve the above-mentioned problem. For example, document U.S. Pat. No. 5,964,834 discloses a method involving the enrolling of the computers to a system implementing a shared clipboard. Whenever a block of information is inserted into the (system) clipboard of a computer, the same block of information is automatically replicated in the clipboards of all the other computers.

However, the solution proposed in the cited document requires a master program running in the network to allow the enrolling of the computers; moreover, an additional program is required on each computer to implement the synchronization of the different clipboards (exploiting listen/broadcast capabilities). A further drawback is that any user can enroll in the system (and then retrieve the blocks of information in the shared clipboard); as a consequence, the proposed system does not provide any control of the privacy of the information shared in the network.

The introduction of document U.S. Pat. No. 5,964,834 also discusses some manual techniques available for sharing information in the network. For example, a user can insert the block of information into the clipboard of a computer; the block of information is then pasted from the clipboard into a mail facility or into a file in a shared volume. In both cases, the block of information can be retrieved in a different computer receiving the mail or accessing the shared file.

However, as indicated in the cited document, those techniques are time consuming; particularly, they require several manual operations to be carried out on both the computers.

A different solution is proposed in document U.S. Pat. No. 5,752,254. This document discloses a system integrating the internal clipboard(s), the system clipboard and the shared clipboard on each computer of the network; in this way, the user can perform operations on a single (virtual) clipboard, regardless of its current type.

In any case, the solution of the cited document suffers the same drawbacks pointed out in the foregoing (i.e., complexity and lack of privacy).

### SUMMARY OF THE INVENTION

It is an object of the present invention to provide a method and a corresponding system for sharing information in a network of computers, which method and system are simple but easy to use.

It is another object of the present invention to avoid having complex programs running in the network and on every computer for supporting the method.

It is yet another object of the present invention to implement the sharing of information without requesting any listen/broadcast capability on the computers of the network.

The accomplishment of these and other related objects is achieved by a method of sharing information among at least two data processing entities, the method including the steps of: selecting a block of information on a first one of the data processing entities, storing the block of information in a predefined shared file in response to at least one shortcut command, and retrieving the block of information from the shared file on a second one of the data processing entities in response to at least one further shortcut command.

Moreover, the present invention also provides a computer program for performing the method and a computer program for running on each data processing entity, together with corresponding products storing the programs.

A system for sharing information and a data processing entity for use in the system are also encompassed.

The novel features believed to be characteristic of this invention are set forth in the appended claims. The invention itself, however, as well as these and other related objects and advantages thereof, will be best understood by reference to the following detailed description to be read in conjunction with the accompanying drawings.

### BRIEF DESCRIPTION OF THE DRAWINGS

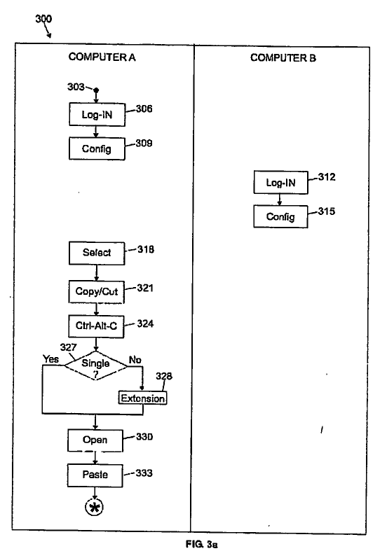

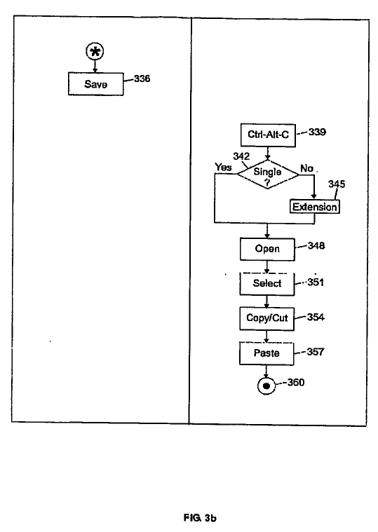

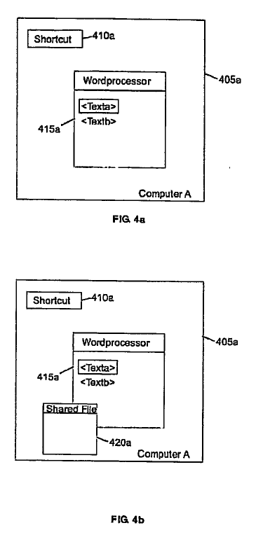

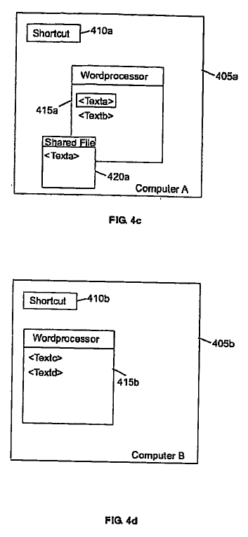

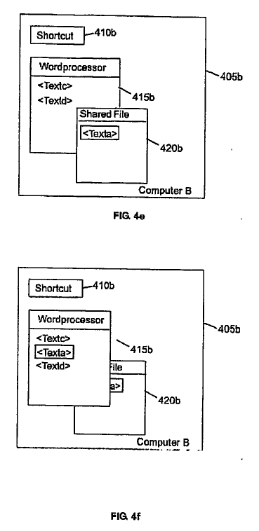

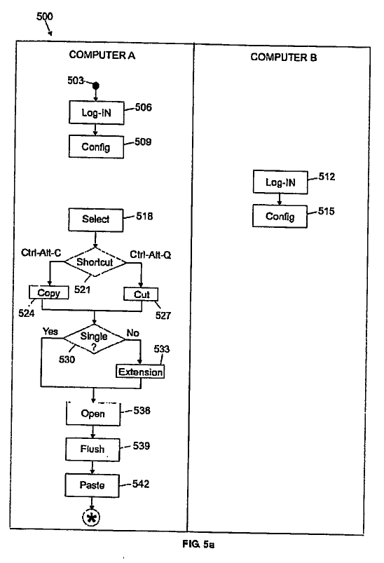

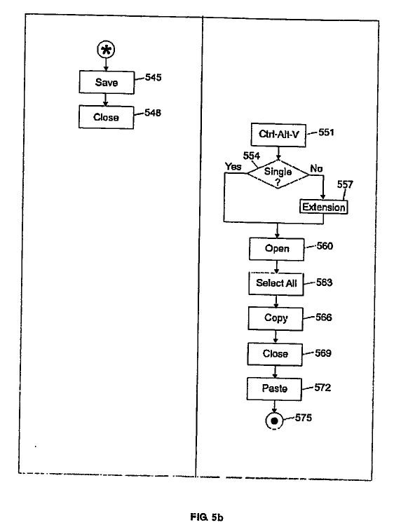

TABLE 1

| | |
|---|---|
| | depicts the functional blocks of a network in which the |
| | method of the invention can be used; |
| | is a pictorial representation of a generic computer of the |
| | network; |
| | shows a partial content of a working memory of the |
| | computer; |
| FIGS. 3a-3b | describe the flow of activities of a method of sharing in- |
| | formation in the network according to an embodiment of |
| | the present invention; |
| FIGS. 4a-4f | illustrate an example of the sequence of operations involved |
| | by the execution of the method of the invention; and |
| FIGS. 5a-5b | show a method of sharing information according to an |
| | alternative embodiment of the present invention. |

### DETAILED DESCRIPTION OF THE PREFERRED EMBODIMENT(S)

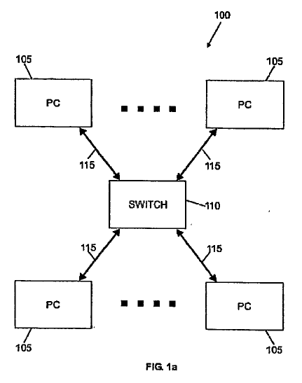

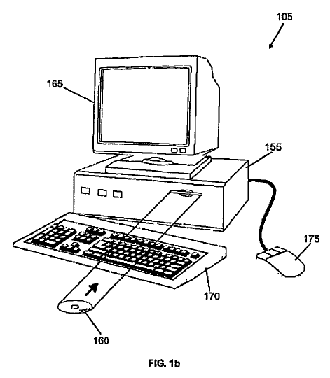

With reference in particular to FIG. 1a, a Local Area Network 100 (LAN) is shown. The network 100 if formed by multiple workstations 105, typically consisting of Personal Computers (PCs). The computers 105 are connected to a switch 110 (acting as a concentrator), through respective communication cables 115. Preferably, two or more computers 105 are located close to each other in the same room, so as to be accessed by a single user (for example, a software developer) at the same time.

Moving to FIG. 1b, a generic computer 105 includes a central unit 155, which houses the electronic circuits controlling its operation (such as a microprocessor and a working memory), in addition to a hard-disk and a driver for CD-ROMs 160. A monitor 165 and a keyboard 170 are connected to the central unit 155 in a conventional manner. The computer 105 further includes a mouse 175, which is used to manipulate the position of a pointer (not shown in the figure) on a screen of the monitor 165.

However, the concepts of the present invention are also applicable when the LAN has a different structure, or it is replaced with an equivalent data processing system (for example, a Wide Area Network or WAN). Similar considerations apply if each computer has a different structure or includes other units. Alternatively, the user works with multiple computers sharing a single input/output assembly (monitor, keyboard and mouse), which is connected to the central unit of the desired computer through a switch device. More generally, the method according to the present invention is suitable to be used for sharing information between two (or more) logic/physic data processing entities (for example, virtual machines running on the same system).

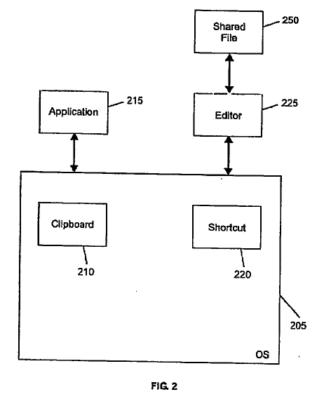

Considering now FIG. 2, a partial content of the working memory of a generic computer of the network is shown; the information (programs and data) is typically stored on the hard-disk and loaded (at least partially) into the working memory when the programs are running. The programs are initially installed onto the hard disk from CD-ROM.

The computer is controlled by an operating system (OS) 205. Particularly, the operating system 205 provides a graphical user interface (GUI). The GUI arranges the screen of the monitor to resemble a desktop, which includes different types of graphical elements (such as an application bar, icons and windows). A user interacts with the computer by generating a sequence of mouse and keyboard commands on the desired graphical elements.

The operating system 205 also implements a clipboard 210, which provides a mechanism to share information between applications 215 running on the computer. In detail, the clipboard 210 consists of a temporary storage area (managed by the operating system 205) that can be used to transfer blocks of information (for example, text, images or sound) within the same application or between different applications 215. For this purpose, a “copy” command is available to duplicate a selected block of information into the clipboard 210; a “cut” command is instead used to move the selected block of information into the clipboard 210. A “paste” command is provided to transfer a copy of the content of the clipboard 210 to a desired destination.

The operating system 205 also includes a module 220 managing the definition and the execution of shortcut commands (or simply shortcuts). In general, a shortcut (also known as alias) is a command that enables the user to perform a desired operation easily (in any case, saving time over its regular invocation). For example, the shortcut consists of an icon (usually placed on the desktop), which links to an executable program; in this way, by double-clicking with the mouse on the icon the program is immediately started (without having to go through complex menus and/or directory tree structures). The shortcut also allows specifying predefined arguments to be passed to the program. In addition, the shortcut may be associated with a special key combination for its invocation; typically, the key combination consists of the Control key (CTRL) and/or the Alternate key (ALT), together with an alphanumeric key. Some shortcuts are already defined in the operating system 205, whereas additional shortcuts can be customized by the user. Typically, the key combinations CTRL-C, CTRL-Q and CTRL-V cause the execution of the commands “copy”, “cut” and “paste”, respectively, on the clipboard 210.

In the computer implementing the method according to the present invention, at least one additional shortcut is predefined. Each shortcut invokes an editor 225 (either directly or through a script), passing the name of a shared file 250 as an argument; the file 250 is stored in a shared directory of a predefined computer of the network. Preferably, the shared file shortcut is associated with a corresponding key combination.

Similar considerations apply if the information is inserted into and retrieved from the clipboard with alternative procedures, or if the shortcuts are defined in another way. Moreover, the concepts of the present invention are also applicable when the clipboard is implemented with a persistent storage area, or when the clipboard stores multiple blocks of information. Alternatively, each shortcut is associated with a pop-up menu entry or with a function key, and the like.

Moving now to FIGS. 3a-3b, the sharing of information between different computers of the network involves the execution of a process 300. The process begins at the black start circle 303 in the swim-lane of a first computer of the network (ComputerA). Proceeding to block 306, a user accesses the ComputerA by typing his/her userID and the corresponding password. In response thereto, the ComputerA is configured at block 309 according to personal preferences that have been predefined for the user; particularly, the desktop is updated to include an icon for the shared file shortcut; the shared file shortcut is associated with the key combination CTRL-ALT-C. The same operations are performed on a second computer (ComputerB) at blocks 312 (log-in) and 315 (configuration).

Referring back to the swim-lane of the ComputerA, the user at block 318 selects a block of information in a current application. The selected block of information is copied (key combination CTRL-C) or cut (key combination CTRL-Q) into the clipboard of the ComputerA at block 321. The process continues to block 324, wherein the user selects the shared file shortcut (for example, typing the key combination CTRL-ALT-C). The process then branches at block 327 according to the configuration of the shared file shortcut. If the shared file shortcut supports multiple types of shared files, a script is invoked at block 328 prompting the user to select an extension of the desired shared file (corresponding to the nature of the information to be managed); the process then passes to block 330. Conversely, if the shared file shortcut supports a single type of shared file the process descends into block 330 directly.

Considering now block 330, the shared file is opened invoking the corresponding editor. The name of the shared file (for example, “MyName”) is predefined. Preferably, the shared file is stored on a computer of the network (for example, “MainComputer”) within a directory dedicated to the user (for example, “users\UserID”). If a single type of shared file is supported (for example, with the extension “MyExt”), the shared file shortcut directly invokes the editor passing the complete network path to the shared file (“\\MainComputer\users\UserID\MyName.MyExt” in the example at issue). On the contrary, if multiple types of shared files are supported the script invokes the editor associated with the selected shared file (for example, a wordprocessor for a text file, a graphical editor for a multimedia file, and so on). The process continues to block 333, wherein the user pastes the content of the clipboard (key combination CTRL-V) into the shared file. The shared file is then saved at block 336.

Moving now to block 339 in the swim-lane of the ComputerB, the user selects again the shared file shortcut (CTRL-ALT-C). If the shared file shortcut supports multiple types of shared files (decision block 342), the user at block 345 selects the extension of the desired shared file, and the process then passes to block 348; conversely, the process descends into block 348 directly. Considering now block 348, the shared file is opened on the ComputerB (invoking the corresponding editor).

The flow of activities continues to block 351, wherein the user selects a block of information in the shared file (for example, consisting of the same block of information, or a portion thereof, from the ComputerA). The selected block of information is copied (key combination CTRL-C) or cut (key combination CTRL-Q) into the clipboard of the ComputerB at block 354. Proceeding to block 357, the user can now paste (key combination CTRL-V) the content of the clipboard to the desired destination on the ComputerB. The process then ends at the concentric white/black stop circles 360.

An example of the sequence of operations involved by the execution of the above-described process is shown in FIGS. 4a-4f. With reference in particular to FIG. 4a, a desktop 405a of the ComputerA includes an icon 410a for the shared file shortcut; moreover, a wordprocessor runs in a window 415a. The user selects a block of text in the window 415a; for example, the block <TEXTa> (highlighted in the figure) is selected by positioning the pointer at its beginning and then dragging the pointer (i.e., moving the mouse while its left-button is held down) over the desired text. The selected block of text is then copied into the clipboard (key combination CTRL-C) of the ComputerA. Moving to FIG. 4b, the user selects the shortcut icon 410a (or types the key combination CTRL-ALT-C). As a consequence, the shared file is opened in a further window 420a. As shown in FIG. 4c, the user can paste the content of the clipboard (<TEXTa>) into the shared file (key combination CTRL-V); the shared file is then saved.

Moving now to FIG. 4d, a desktop 405b of the ComputerB likewise includes an icon 410b for the shared file shortcut and a window 415b for a further wordprocessor. As soon as the user selects the shortcut icon 410b (or types the key combination CTRL-ALT-C), the shared file is opened in a further window 420b (as shown in FIG. 4e). The user selects the content of the shared file in the window 420b (<TEXTa>), and copies the selected block of text into the clipboard (key combination CTRL-C) of the ComputerB. Referring now to FIG. 4f, the user can paste (key combination CTRL-V) the content of the clipboard to the desired position in the window 415b.

Similar considerations apply if the process implements an equivalent method, or if different key combinations are defined. Moreover, the concepts of the present invention are also applicable when the user copies or cuts multiple blocks of information into the shared file, when the information is moved from the shared file to the desired position, and the like.

An alternative embodiment of the method according to the present invention is illustrated in the activity diagram of FIGS. 5a-5b. In this case, three different shared file shortcuts are defined on each computer. In detail, a shortcut defined for a shared copy command is associated with the key combination CTRL-ALT-C, a shortcut defined for a shared cut command is associated with the key combination CTRL-ALT-Q, and a shortcut defined for a shared paste command is associated with the key combination CTRL-ALT-V.

The proposed solution implements a process 500 that begins at the black start circle 503 in the swim-lane of the ComputerA. The user accesses the ComputerA (block 506), which is then configured accordingly (block 509); the same operations are performed on the ComputerB at blocks 512 (log-in) and 515 (configuration).

Referring back to the swim-lane of the ComputerA, the user at block 518 selects a block of information in a current application. The blocks 518-548 are then automatically executed in response to the selection of a shared file shortcut (key combinations CTRL-ALT-C or CTRL-ALT-Q). In detail, the process branches at block 521 according to the shared file shortcut. If the user has typed the shared copy command (key combination CTRL-ALT-C), the selected block of information is copied into the clipboard of the ComputerA at block 524; conversely, if the user has typed the shared cut command (key combination CTRL-ALT-Q), the selected block of information is cut into the clipboard of the ComputerA at block 527. This requires that the command triggered by the key combination CTRL-ALT-C or CTRL-ALT-Q includes the execution of macros able to send a copy event or a cut event, respectively, to the application wherein the block of information has been selected. In both cases, the process then continues to block 530.

Considering now decision block 530, if the shared file shortcuts support multiple types of shared files, the extension of the desired shared file is selected at block 533; the process then passes to block 536. Conversely, the process descends into block 536 directly. Moving to block 536, the shared file is opened on the ComputerA (invoking the corresponding editor).

A macro is automatically called at block 539, in order to flush the shared file (for example, selecting and then deleting its whole content). The process continues to block 542, wherein the content of the clipboard is pasted into the shared file. The shared file is then saved at block 545 and closed at block 548.

Moving now to block 551 in the swim-lane of the ComputerB, the user types the shared paste command (key combination CTRL-ALT-V). In response thereto, the blocks 554-572 are automatically executed. Particularly, if the shared file shortcuts support multiple types of shared files (decision block 554), the user at block 557 selects the extension of the desired shared file; the process then passes to block 560. Conversely, the process descends into block 560 directly. Considering now block 560, the shared file is opened on the ComputerB (invoking the corresponding editor). A macro is automatically called at block 563, in order to select the whole content of the shared file (consisting of the block of information from the ComputerA). The selected block of information is copied into the clipboard of the ComputerB at block 566. The process continues to block 569, wherein the shared file is closed. Proceeding to block 572, the content of the clipboard is pasted to the desired destination on the ComputerB. The process then ends at the concentric white/black stop circles 575.

Similar considerations apply if equivalent commands are supported, or if two different shortcuts are provided for duplicating or moving, respectively, the content of the shared file to the desired position. Moreover, the concepts of the present invention are also applicable when the shared file is flushed in a different way (for example, deleting and re-creating the shared file during the execution of every copy/cut shared command). Alternatively, a more sophisticated embodiment of the present invention supports an array of shared files (which are used like a FIFO stack by the shared copy/cut commands and are selected by the user during the shared paste operation).

More generally, the present invention proposes a method of sharing information among at least two data processing entities. The method starts with the step of selecting a block of information on a first one of the data processing entities. The block of information is stored in a predefined shared file in response to one or more shortcut commands. The method then includes the step of retrieving the block of information from the shared file on a second one of the data processing entities in response to one or more further shortcut commands.

The solution of the invention provides a method for sharing information, which method is simple but at the same time easy to use.

This result is achieved without any complex programs (for example, running in the network and on every computer).

Particularly, the implementation of the devised solution does not require any listen/broadcast capability on the data processing entities.

The preferred embodiments of the invention described above offer further advantages.

In a first implementation, the transfer of the block of information into the clipboard is carried out by the user manually copying/cutting the block of information into the clipboard, selecting the shared file shortcut, and then pasting the block of information into the shared file.

The proposed method is very simple, since it requires the definition of a single shortcut on every computer (simply invoking an editor associated with the shared file to be opened); moreover, the method is flexible and allows the user to perform any desired operation on the shared file.

Preferably, the retrieval of the block of information is carried out by the user manually opening the shared file with the same shortcut, copying/cutting a further block of information into the clipboard, and then pasting the further block of information.

The proposed method permits implementing all the operations on the shared file with a singleshortcut; moreover, this method allows the user to select any desired portion of the content of the shared file.

In a different embodiment of the invention, a shared copy command and a shared cut command are provided; the selection of one of those commands involves the automatic execution of the steps of copying/cutting the block of information into the clipboard, flushing the shared file, pasting the block of information into the shared file, and then saving the same.

In this way, blocks of information can be transferred to the shared file with a single command (similar to the one available for the clipboard).

Moreover, the selection of the shared paste command involves the automatic execution of the steps of opening the shared file, copying its content into the clipboard, and then pasting the block of information.

In this way, all operations on the shared file can be controlled with commands quite similar to the ones available for the clipboard.

However, the method according to the present invention leads itself to be implemented only with one of the above-described features (for example, selectable by the user at run-time or during a configuration process), or with different procedures for storing the block of information in or for retrieving the block of information from the shared file. Alternatively, the features of the two proposed embodiments can be combined in a different way (for example, with the shared copy/cut commands for automatically storing the block of information into the shared file and with the shared paste command for manually retrieving the block of information from the shared file).

As a further enhancement, the user can select the extension of the shared file.

The proposed feature permits using different shared files (and corresponding editors), according to the type of information to be transferred.

A way to further improve the solution is to support multiple shared files, each one for a corresponding user; whenever the user accesses a computer of the network, the computer is configured so as to include one or more shortcuts for the respective shared file(s).

In this way, each shared file is available to the authorized user only; this result is achieved automatically without any manual intervention on the computers.

In any case, the method of the invention is also suitable to be implemented supporting a single type of shared file, with the shortcuts on all the computers that are associated with the same shared file, or even without any control of the access to the shared file.

Advantageously, the solution according to the present invention is implemented with a computer program, which is provided as a corresponding product stored on a suitable medium. Preferably, the same program is installed on each data processing entity.

Alternatively, the program is pre-loaded onto the hard-disks, is sent to the computers through the network, is broadcast, or more generally is provided in any other form directly loadable into the working memories of the data processing entities. However, the method according to the present invention leads itself to be carried out even with a hardware structure (for example, integrated in a chip of semiconductor material).

The present invention also proposes a corresponding system for sharing information. Moreover, it should be noted that each data processing entity is typically put on the market as a stand-alone product, suitable to the configured for use in a pre-existing system implementing the solution of the invention.

Naturally, in order to satisfy local and specific requirements, a person skilled in the art may apply to the solution described above many modifications and alterations all of which, however, are included within the scope of protection of the invention as defined by the following claims.

1. A method (300;500) of sharing information among at least two data processing entities, the method including the steps of:
selecting (318;518) a block of information on a first one of the data processing entities,
storing (321-336;521-548) the block of information in a predefined shared file in response to at least one shortcut command, and
retrieving (339-357;551-572) the block of information from the shared file on a second one of the data processing entities in response to at least one further shortcut command.

2. The method (300) according to claim 1, wherein the at least one shortcut command includes a customized shortcut command, the step of storing (321-336) the block of information in the shared file including:
inserting (321) the block of information into a first clipboard of the first data processing entity,
opening (324-330) the shared file in response to the shortcut command,
pasting (333) the block of information from the first clipboard into the shared file, and
saving (336) the shared file.

3. The method (300) according to claim 2, wherein the at least one further shortcut command consists of the shortcut command, the step of retrieving (339-357) the block of information on the second data processing entity including:
opening (339-348) the shared file in response to the shortcut command,
selecting (351) a further block of information in the shared file,
inserting (354) the further block of information into a second clipboard of the second data processing entity, and
pasting (357) the further block of information from the second clipboard.

4. The method (500) according to claim 1, wherein the at least one shortcut command consists of a first and a second shortcut commands, the step of storing (521-548) the block of information in the shared file including the automatic execution of the following steps in response to each shortcut command:
copying (524) or cutting (527) the block of information into a first clipboard of the first data processing entity in response to the first shortcut command or to the second shortcut command, respectively,
flushing (530-539) the shared file,
pasting (542) the block of information from the first clipboard into the shared file, and
saving (545) the shared file.

5. The method (500) according to claim 4, wherein the at least one further shortcut command consists of a third shortcut command, the step of retrieving (551-572) the block of information on the second data processing entity including the automatic execution of the following steps in response to the third shortcut command:
opening (551-560) the shared file,
selecting (563) the block of information in the shared file,
inserting (566) the block of information into a second clipboard of the second data processing entity, and
pasting (572) the block of information from the second clipboard.

6. The method (300;500) according to any claim from 1 to 5, further including the step of selecting (328,345;533,557) an extension of the shared file on the first and second data processing entities.

7. The method (300;500) according to any claim from 1 to 6, wherein a predefined one of the data processing entities stores a plurality of shared files assigned to corresponding users, the method further including the step of:
configuring (309;315;509;515) each data processing entity in response to a log-in of a user to include the at least one shortcut command and the at least one further shortcut command for each shared file assigned to the user.

8. A computer program (220,225), directly loadable into a working memory of a system (100) including at least two data processing entities (105), for performing the method of any claim from 1 to 7 when the program is run on the system.

9. A computer program (220,225), directly loadable into a working memory of a data processing entity (105), for performing a method of sharing information among at least two data processing entities when the program is run on the data processing entity, the method including the steps of:
selecting (318;518) a block of information,
storing (321-336;521-548) the block of information in a predefined shared file in response to at least one shortcut command, and
retrieving (339-357;551-572) the block of information from the shared file in response to at least one further shortcut command.

10. A program product (160) comprising a computer readable medium on which the program (220,225) of claim 8 or 9 is stored.

11. A system (100) for sharing information among at least two data processing entities (105), the system including means (170,175) for selecting a block of information on a first one of the data processing entities, means (210,220,225) for storing the block of information in a predefined shared file in response to at least one shortcut command, and means (210,220,225) for retrieving the block of information from the shared file on a second one of the data processing entities in response to at least one further shortcut command.

12. A data processing entity (105) for use in a system (100) for sharing information among at least two data processing entities, the data processing entity including means (170,175) for selecting a block of information, means (210,220,225) for storing the block of information in a predefined shared file in response to at least one shortcut command, and means (210,220,225) for retrieving the block of information from the shared file in response to at least one further shortcut command.
